(19) United States
(12) Patent Application Publication
(10) Pub. No.: US 2015/0234786 A1
(43) Pub. Date: Aug. 20, 2015

(54) E-READER DEVICE TO DISPLAY CONTENT FROM DIFFERENT RESOURCES ON A PARTITIONED DISPLAY AREA

(71) Applicant: Kobo Inc., Toronto (CA)

(72) Inventor: Benjamin Landau, Toronto (CA)

(73) Assignee: Kobo Inc., Toronto (CA)

(21) Appl. No.: 14/181,231

(22) Filed: Feb. 14, 2014

(51) Int. Cl. G06F 17/21; G06F 3/0482; G06F 3/0488; G06F 3/0483

(52) U.S. Cl. CPC G06F 17/211; G06F 3/0483; G06F 3/0482; G06F 3/0488

(57) ABSTRACT

An e-reader application is executed on a computing device in order to display a content from a first e-book. The e-reader application includes a first set of features for use with the first e-book. While displaying the content from the first e-book, a partition is implemented that segments a display area of a display into a first segment and a second segment. The partition is further implemented by providing the content and the set of features on only the first segment, and enabling selection of another resource from a plurality of possible resources using the e-reader application. In response to selection of the other resource, content is displayed based on the selected other resource on only the second segment of the display area.

### TECHNICAL FIELD

Examples described herein relate to an e-reader device that displays content from different resources on a partitioned display area.

### BACKGROUND

An electronic personal display is a mobile electronic device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., AmazonKindle®, Barnes and Noble Nook®, Kobo Aura HD, and the like).

An electronic reader, also known as an e-reader, is an electronic personal display that is used for reading electronic books (eBooks), electronic magazines, and other digital content. For example, digital content of an eBook is displayed as alphanumeric characters and/or graphic images on a display of an e-reader such that a user may read the digital content much in the same way as reading the analog content of a printed page in a paper-based book. An e-reader provides a convenient format to store, transport, and view a large collection of digital content that would otherwise potentially take up a large volume of space in traditional paper format.

In some instances, e-readers are purpose built devices designed to perform especially well at displaying readable content. For example, a purpose built e-reader may include a display that reduces glare, performs well in high light conditions, and/or mimics the look of text on actual paper. While such purpose built e-readers may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for operating a computing device to enhance electronic reading activity, according to an embodiment.

FIG. 2 illustrates an example of an e-reader device or other electronic personal display device, for use with one or more embodiments described herein.

FIG. 3 illustrates an example device system for enabling display partitioning of e-books, according to an embodiment.

FIG. 4 illustrates a method for partitioning a display screen of an e-reader device, according to one or more embodiments.

FIG. 5A illustrates an example of content displayed by an e-reader device when operating in a default single view mode, according to an embodiment.

FIG. 5B illustrates an example of the page view after an initial user interaction with the mufti-view feature.

FIG. 5C illustrates an example of a mufti-view implementation in which the segments of the display area separately display content from different e-books.

FIG. 5D illustrates an example of a mufti-view implementation in which the segments of the display area separately display content from different portions of the same e-book.

FIG. 5E illustrates a mufti-page view in which input features are provided for each segment of the display area, according to an embodiment.

### DETAILED DESCRIPTION

Examples described herein include an e-reader device that can implement a mufti-view mode, in which the display area of the device is visually and logically partitioned into segments in order to display different resources at the same time. By way of example, an e-reader device can be operated to partition its display area into multiple display segments in order to display portions of different e-books, or different portions of the same e-book on each segment.

According to one aspect, an e-reader device can provide input features with each segment in order to enable the user to independently control the display of content within each segment. The segments of the partitioned display area can display content from the same e-book independently, as well as content from two different e-books at the same time. In variations, other forms of content can be displayed in one or both of the segments, such as, for example, a library view from which the user can select a second e-book to view, while content from a current e-book is on display in another segment.

An e-reader application is executed on a computing device in order to display a content from a first e-book. The e-reader application includes a first set of features for use with the first e-book. While displaying the content from the first e-book, a partition is implemented that segments a display area of a display into a first segment and a second segment. The partition is further implemented by providing the content and the set of features on only the first segment, and enabling selection of another resource from a plurality of possible resources using the e-reader application. In response to selection of the other resource, content is displayed based on the selected other resource on only the second segment of the display area.

With examples described herein, an e-book can have pagination and/or chapter designations, and a format such as Electronic Publication (“EPUB”), APABI, Hypertext Markup Language (“HTML”), iBOOK, KF8, MICROSOFT LIT, AZW, or Digital Accessible Information System (“DAISY”).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

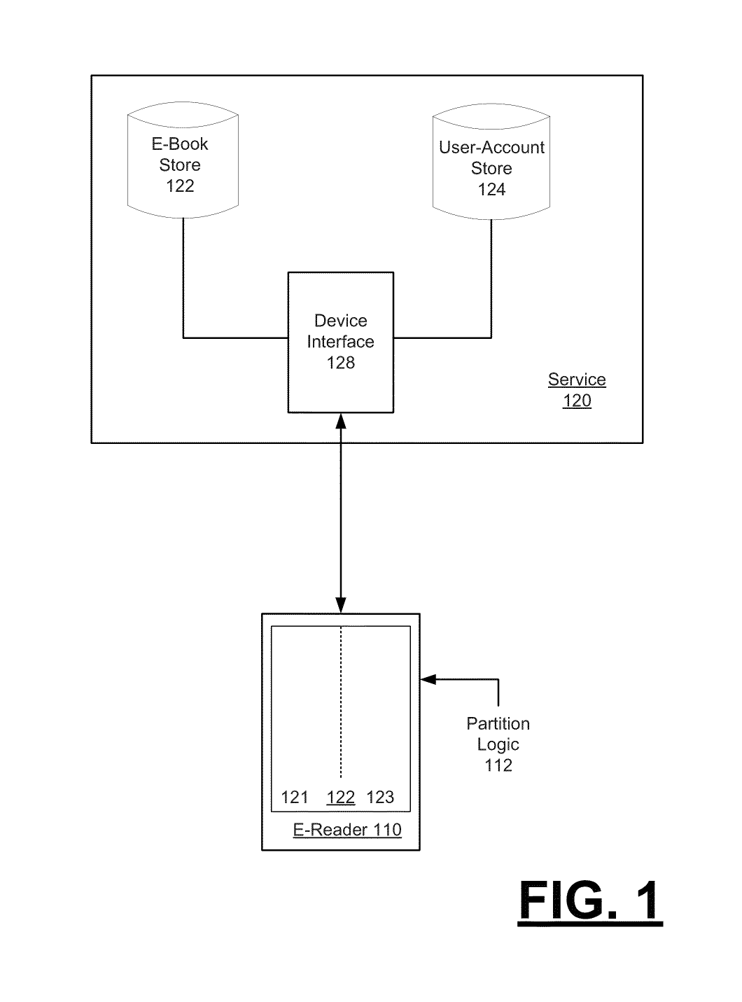

FIG. 1 illustrates a system for operating a computing device to enhance electronic reading activity, according to an embodiment. In an example of FIG. 1, the system includes an electronic display device, shown by way of example as an e-reader device 110, and a network service 120. The network service 120 may include multiple servers and other computing resources that provide various services in connection with one or more applications that are installed on the e-reader device 110. By way of example, in one implementation, the network service 120 can provide e-book services which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. For example, the e-reader device 110 can correspond to a tablet or a telephony/messaging device (e.g., smart phone). In one implementation, for example, e-reader device 110 can run an e-reader application that links the device to the network service 120 and enables e-books provided through the service to be viewed and consumed. In another implementation, the e-reader device 110 can run a media playback or streaming application which receives files or streaming data from the network service 120. By way of example, the e-reader device 110 can be equipped with hardware and software to optimize certain application activities, such as rendering of electronic content (e.g., e-books). For example, the e-reader device 110 can have a tablet like form factor, although variations are possible. In some cases, the e-reader device 110 can also have an E-ink display.

In additional detail, the network service 120 can include a device interface 128, a resource store 122 and a user account store 124. The user account store 124 can associate the e-reader device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

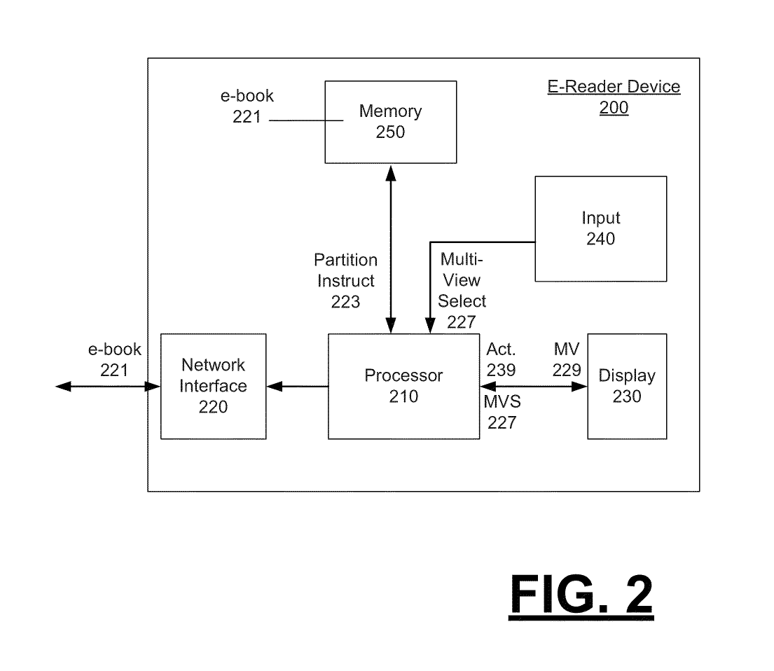

With reference to FIG. 1, the e-reader device 110 includes a display area 122 on which text content from selected e-books can be rendered. As described in example of FIG. 2, the display area 122 can be configured as a touch sensitive component of a display assembly on which input features are provided or are otherwise enabled. By way of example, the input features can include soft buttons or hidden touch regions where the user can transition pages from an e-book, looking words up (using a dictionary function).

In an embodiment, the e-reader device 110 includes partitioning logic 112 to partition the display area 122 into segments 121, 123. When the partition logic 112 is implemented, the e-reader device 110 can be said to switch from a single view mode to a multi-view mode. While some examples described herein describe a single partition that forms two segments 121, 123 for display area 122, in variations, multiple partitions can be used to create three or more segments. In the context of the reading activities, each segment can be operated by the user independently of the other segment. In other words, each of the segments 121, 123 can receive and process input independently of the other segment. In an example of FIG. 1, the user can provide input that selects the first segment 121 to render content from a first e-book, and input that selects the second segment 123 to render content from a second e-book. Thus, for example, the user can execute the e-reader application to open and view two different e-books at the same time. As another example, the user can view a first instance of an e-book in the first segment 121, and a second instance of the same e-book and the segment 123. In this way, the user can view two different portions of the same e-book at the same time. Still further, one segment of the display area 122 can be used to view an e-book library, or the network service 120.

The partition logic 112 can provide each segment 121, 123 of the display area 122 with different sets of input features, to enable content and functionality that is specific to the particular segment. In one implementation, the segments 121, 123 can provide duplicate sets of input features that allow the user to control the manner in which content is displayed on each respective segment. For example, the partition logic 112 can incorporate the same page turning feature on each of the segments 121, 123. In this way, the user can transition pages of one e-book and not transition pages of another e-book, and vice versa. The user can also transition pages of two e-books at the same time. Still further, in some variations, the user can transition pages of two different e-books at the same time but at different rates, or alternatively, transition one e-book appearing on the first segment 121 by chapter and another e-book appearing on the second segment 123 by clustered pages. Multiple such variations are possible with examples described here.

Hardware Description

FIG. 2 illustrates an example of an e-reader device or other electronic personal display device, for use with one or more embodiments described herein. In an example of FIG. 2, an e-reader device 200 can correspond to, for example, a device, such as also shown by an example of FIG. 1. With reference to FIG. 2, e-reader device 200 includes a processor 210, a network interface 220, a display 230, one or more input mechanisms 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources, such as e-books 221 or media files that the user elects to purchase or otherwise download from the network service 120. The application resources that are downloaded onto the e-reader device 200 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. In some variations, the display 230 can correspond to an electronic paper type display, which mimics conventional paper in the manner in which they display content. Examples of such display technologies include electrophoretic displays, electrowetting displays, and electrofluidic displays.

The processor 210 can receive input from various sources, including from input mechanisms 240 (e.g., buttons or switches, microphone, keyboard), the display 230 (e.g., soft buttons or keyboard) or other input mechanisms (accessory devices). The processor 210 can further communicate with the display 240 in order to define a display area, as well as segments of the display area, as described with examples provided below.

The memory 250 can store instructions 223 for implementing the partition logic 112 (see FIG. 1). The memory 250 can also store e-books 221, including e-books that can be, for example, downloaded from the network service 120 (see FIG. 1). One embodiment provides that by default, the processor 210 can implement a single view mode, and then switch into a multi-view mode upon the occurrence of an event (e.g., user input). In one implementation, the processor 210 can execute instructions 223 in order to implement a mufti-view mode of operation in which the display screen is partitioned into multiple segments. The processor 210 can execute instructions 223 in response to receiving a user selection 227. The user selection 227 can be provided by input mechanism 240 and/or display 230.

Once the mufti-view mode of operation is implemented, the processor 210 can signal multi-view control 229 to the display 240. In turn, the display 240 can output multiple segments over a given display area. In one implementation, multi-view control 229 replicates soft input features onto each of the segments. By way of example, multi-view control 229 can replicate controls for enabling the user to perform page turns, chapter turns, adjust settings, and/or dictionary or translation actions. Accordingly, display 230 can receive activity input 239 from the user. The activity input 239 can correspond to input provided by the user in regards to the user's reading activities then the multi-view mode is implemented. The activity input 239 can be provided in a manner that is specific for a particular display segment and content. In this way, the response of the processor 210 to the activity input 239 can be specific to the content provided on a particular segment, without affecting the content provided on the other segment. The user's input and control of a particular segment can be decoupled from the other segment, so that activities performed with one segment are independent and separate from the output on the other segment.

Device System

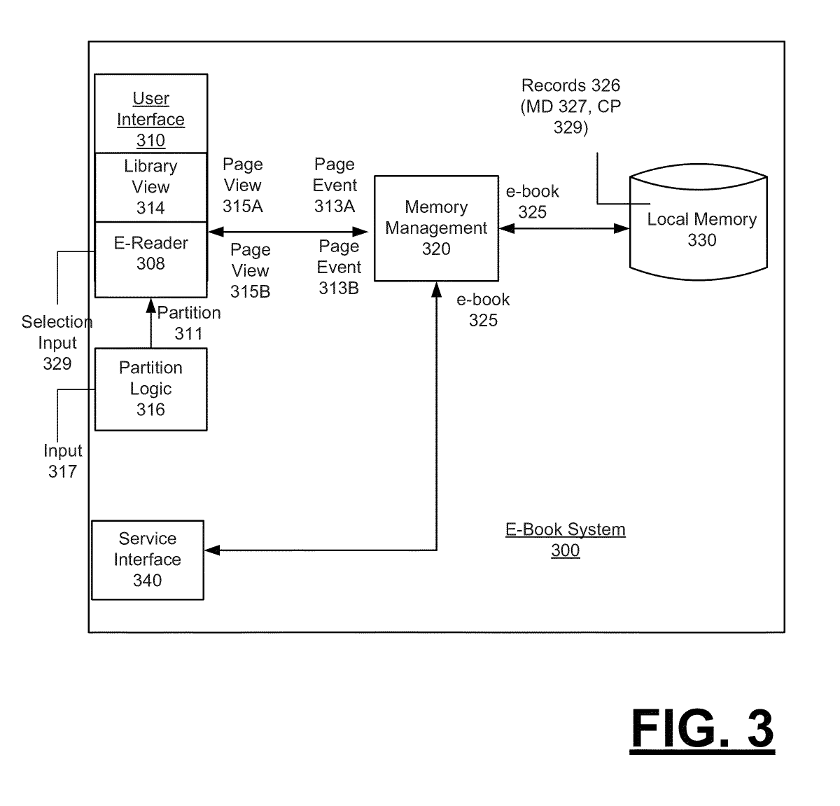

FIG. 3 illustrates an example device system for enabling display partitioning of e-books, according to an embodiment. In reference to FIG. 3, a system 300 implements programmatic components for communicating with an e-book service (such as network service 120, shown in FIG. 1), as well as for enabling functionality for viewing and accessing e-books utilized by an account associated with the e-reader device 110 (see FIG. 1 or FIG. 2). In some embodiments, the system 300 can be implemented as an application that runs on an e-reader device, such as shown with examples of FIG. 1 or FIG. 2.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reader device 110. For example, the user can download an application onto the device that is operated as the e-reader device 110, in order to obtain functionality such as described with an example of FIG. 3. For example, the user can download an application onto an e-reader device, to obtain functionality such as described herein, as well as to communicate with the network service 120. Alternatively, an application can be embedded or otherwise preinstalled with other programmatic elements for providing functionality such as described with system 300.

The service interface 340 includes application logic which enables the e-reader device 110 to use, for example, a wireless Internet connection, to connect to the network service 120 (see FIG. 1). In connecting with the service, the service interface 340 can transmit data that enables the network service 120 to identify the e-reader device 110 on which system 300 is implemented, so that the network service 120 can determine the account that is associated with the particular e-reader device. The service interface 340 can be used to retrieve e-books 325 from the network service 120. For example, in identifying the e-reader device 110 of system 300 to the network service 120, the network service may be able to procure payment information (e.g., stored credit card information) that can be used to charge the users account when the user purchases a new e-book from the service. Each e-book can correspond to a literary work having a pagination format. Optionally, some e-books may have chapter designations, as well as content that corresponds to graphics or images (e.g., such as in the case of magazines or comic books). Individual e-books 325 can also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reader device of system 300, the network service 120 can identify what e-books belong to the account associated with the particular device. The e-books that are transmitted to the e-reader device of system 300 include those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reader device 110 to automatically receive their previously purchased e-book. As another example, network service 120 can be configured to push e-books to the e-reader device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-book device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The management module 320 can retrieve portions of individual e-books for purpose of rendering e-books via the user interface 310.

In an example of FIG. 3, the user interface 310 of e-book system 300 includes an e-reader component 308, a library view component 312, and partition logic 316. In one implementation, the partition logic 316 is an integrated component of the user interface 310. In another implementation, the partition configuration 311 is a plug-in, or a standalone application which provides functionality such described.

The e-reader component 308 displays content from a given e-book of the user selection via the memory management 320 and/or local memory 330. In implementation, the content can correspond to page view 315A, corresponding to a page provided by the content portion 329 of the selected e-book. The e-reader component 308 defines the display area on which the page view 315A is provided. When single view mode is in place, the page view 315A can, for example, be provided on a substantial portion (e.g., greater than 80%) of the total display area provided by the display of the corresponding e-reader device. The user can interact with the e-reader component 308 by signaling, for example, page events 313A, which can include page turn input, chapter turn input, or multipage turn input. Other kinds of input they can be signaled by the user via the e-reader component 308 include settings input, menu navigation input, and other functionality (e.g., dictionary input).

The partition logic 316 can be responsive to user input 317. For example, the e-reader component 308 can include a selection feature that provides a prompt for user selection in order to implement the mufti-view mode. In response to detecting user input 317, partition logic 316 signals partition configuration 311 to the e-reader component 308. The e-reader component 308 implements the partition logic 316 by segmenting the display area into two or more segments.

In one implementation, the content from the e-book being rendered is automatically displayed on one of the two segments created through the partition configuration 311. The content for the other segment can be selected by a manual and/or programmatic process. In one implementation, partition logic 316 further enables the user to provide input, such as navigational and/or selection input, in order to identify and select content for display in the other segment provided as a result of the partition configuration 311. For example, the first segment created by the partition configuration 311 can automatically display content corresponding to page view 315A (the current e-book), and the second segment can display content for enabling user selection of another e-book that is either locally stored or provided on a network. More specifically, the user can select one or more sources for selecting a second e-book to view on the alternative segment of the display area. In particular, the user can view one or more of (i) a collection of e-books on the e-reader device of the mobile computing system, (ii) a user's online collection (e.g., associated with the user's account), and/or (iii) an online e-book store. As another example, the user can view a short list of e-books that are in process of being read or still unread. As another variation, the second e-book can be automatically selected. For example, the content for the second segment can automatically be selected by default to coincide with the current page of another e-book that the user has initiated reading, or has most recently read.

In an example of FIG. 3, the e-reader component 308 can process selection input 329 from the user in order to identify a second e-book to display in the second segment of the display area. Alternatively, the selection input 329 can identify a second instance of the current e-book on display when the multi-view mode is initiated. As still another input, the selection input 329 can be made programmatically, such as by default or user setting. The e-reader component 308 can display, for example, a first page, or a most recently read page of the e-book selected by selection input 329. In displaying content for the e-book for the second segment, the e-reader component 308 can retrieve or receive page view 315B from the memory management module 320 and/or local memory 330. The page views 315A (text content from e-book for first segment), 315B (text content from e-book for second segment) are displayed by the e-reader component 308 on the display screen at the same time.

The e-reader component 308 also implements the partition configuration 311 by providing separate input features with each segment. In one implementation, the selected input features are specific to the content or content type (e.g., e-book) being displayed on each segment. For example, if each segment displays content from an e-book, the partition configuration 311 provides that the e-reader application 308 displays input features on each segment for performing e-reading activities. The features provided can enable e-reading activities that correspond to one or more of (i) page turning, (ii) settings, and/or (iii) dictionary/translation input. If one of the segments displays a library, collection or other source (e.g., online store), other functions inherent with the respective sources can be displayed on that segment. For example, input features can be provided on the alternative segment that enables the user to navigate or search a collection, make selections, or purchase and/or download e-books.

The content provided on each segment can change based on events, such as user input. For example, the user can use one of two segments to view a collection of e-books and make a selection. Once the selection is made, the second segment of the partitioned display screen can then display page view 315B, corresponding to content from the selected e-book.

In some embodiments, e-reader application 308 can process input from each segment of the display area. When each segment displays an e-book, each segment can receive and process respective page events 313A, 313B. The inputs for page events 313A, 313B can be processed independently of one another. Likewise, each segment can display page views 315A, 315B independently of the other segment.

Methodology

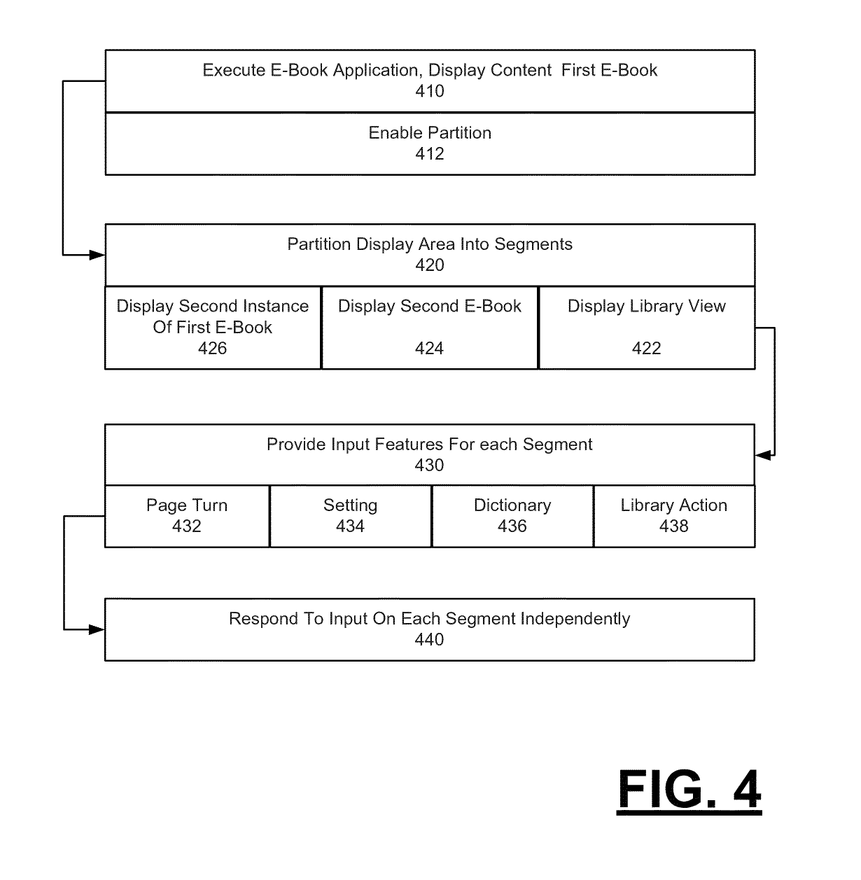

FIG. 4 illustrates a method for partitioning a display screen of an e-reader device, according to one or more embodiments. A method such as described by an example of FIG. 4 may be implemented using components such as described with an example of FIG. 1, FIG. 2 or FIG. 3. Accordingly, reference may be made to elements of prior examples for purpose of illustrating suitable components for performing a step or sub-step being described.

With reference to FIG. 4, an e-reader device 110 operates to execute an e-book application, in order to display content from a first e-book (410). For example, the e-reader device 110 can operate the e-reader component 308 in order to display page views 315A from a selected e-book. In some implementations, when the first e-book is displayed, the partition logic can be enabled (412). For example, the page view 315A from the selected e-book can be provided with input features, including input feature to partition the display screen. The input feature can correspond to, for example, an icon, a menu feature or other soft feature that appears on the display screen when content from the first e-book is displayed.

In response to user selection, the e-reader device 110 can partition the display area into two segments (420). Each segment can independently display content from a corresponding e-book. In one implementation, the selection by the user to implement multi-view mode on the display screen results in the display of a library view or other navigational mechanism on the available segment of the display screen (422). Another of the segments of the display screen can be used to display the existing content, such as the page view from the e-book that was on display just prior to the selection of the mufti-view mode.

The user can make selections of another e-book through, for example, interaction with the library view or navigational mechanism provided on the second segment of the display screen. In one implementation, the first segment can display content from the current e-book, and the second segment can be used to display content from a second e-book (424). With reference to FIG. 3, for example, the page views 315A, 315B can provide content from different e-books, but appear on the display screen at the same time. The user can select the second e-book using a navigation process, such as one that enables the user to select an e-book from a collection of e-books that are locally stored, or alternatively provided at an online resource or site.

Still further, in one implementation, the first segment can display content from a current e-book (e.g., the e-book that the user was reading when the partition logic was selected), and the second segment can be used to display content from a second instance of the same e-book (426). With reference to FIG. 3, for example, the page views 315A, 315B can be generated from the same e-book. Thus, for example, the user can independently view different pages of the same e-book on the same display screen of the e-book device 110.

When the mufti-view is implemented, each segment of the display area can be provided with a set of input features for enabling user interaction with the content provided in the respective segment (430). The input features can include, for example, a page turn feature (432). In variations, multipage or chapter turns can also be provided. According to one aspect, the page turn feature can be provided as a soft element on the segment of the display area which user can contact or otherwise provide a designated interaction (e.g., double tap, tap and hold, drag, etc.) in order to affect a page turn. The page turn feature can be provided as a visible feature (e.g., icon), or a hidden feature (e.g., designated touch spot on an edge region) of each segment of the display area).

In a variation, one or more input features can be provided with each segment of the display area in order to trigger a settings function (434). For example, in one aspect, the user can initiate a settings menu by providing pre-selection input, corresponding to interaction with an input feature provided on either one of the segments of the display area. Still further, in some variations, the user's input to affect settings can affect just the content appearing on the particular segment from which the setting menu was selected.

In still another implementation, input can be provided with each segment of the display area in order to trigger ancillary functionality such as a dictionary or translation service (436). For example, the user can perform a dictionary or translation lookup of text items appearing on either segment of the display area. The selection of the text items, as well as the operation to be performed can optionally be performed using input features that are provided for the segment on which the corresponding content is being displayed.

As another variation, one or both segments can provide a library view of the user's local collection, or of a network collection (e.g., user's account store, online e-book store) (438). The library view can be initiated automatically when, for example, the user selects the mufti-view. Alternatively, the library view can be provided as an input feature that the user can select in order to trigger a particular presentation or screen corresponding to a library view on either one or both of the segments of the display area.

While an example such as described with FIG. 4 provides for a partition feature that is implemented when content from a selected e-book is being displayed, variations may provide for triggering implementation of the partition logic and the multi-view mode from other operational context. For example, in some variations, the partition logic can be selected on a navigational screen of the e-reader device 110 independently of displaying content from any e-book. For example, a home screen or navigational screen can include a feature to initiate the partition logic and to display the segments of the mufti-view mode.

According to some embodiments, the e-reader device 110 is able to respond to input provided by user interaction with features provided with either segment of the display area (440). The response of the e-reader device 110 to input received on a particular segment can be specific to that segment. The e-reader device 110 can display content or implement functionality for the segment that received input, without affecting what is displayed on the other segment. In this regard, when the mufti-view mode is implemented, the e-reader device 110 can receive and process input on either segment independent of processes or functionality that are performed in displaying content on the segment.

### Examples

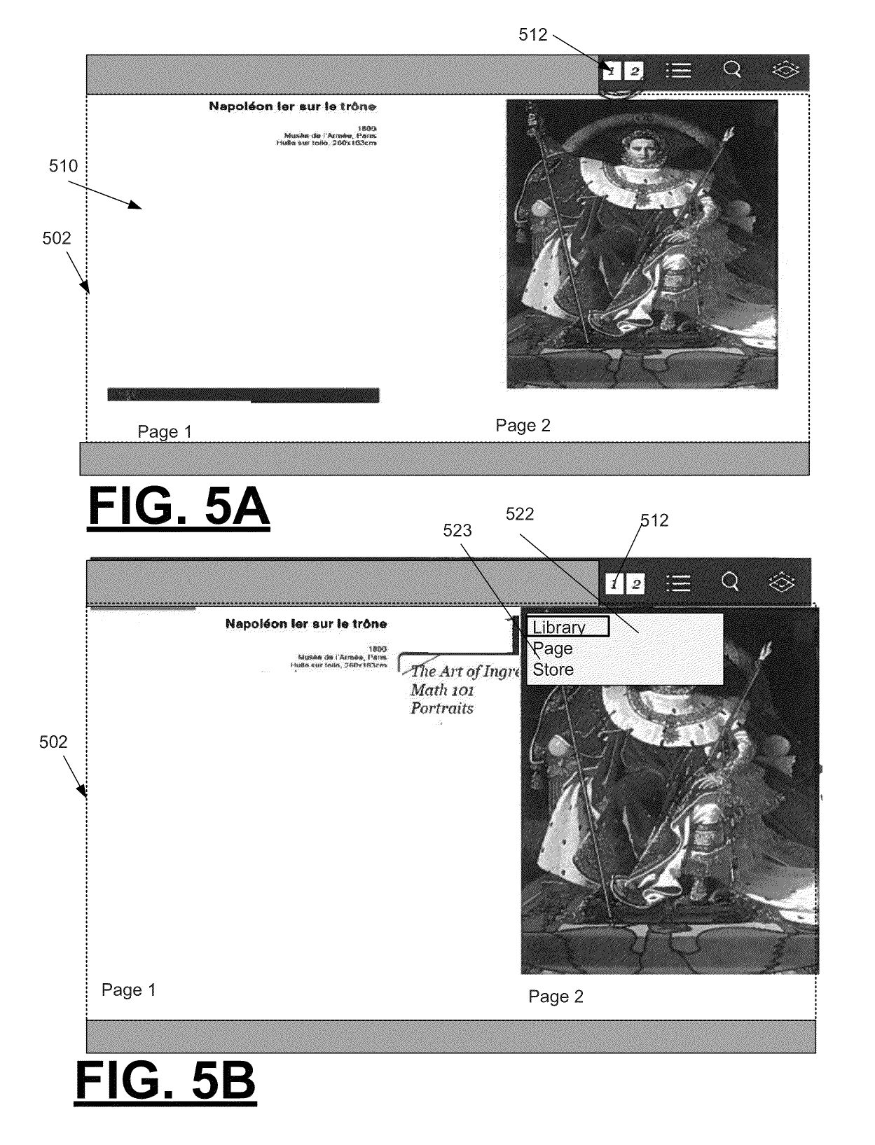

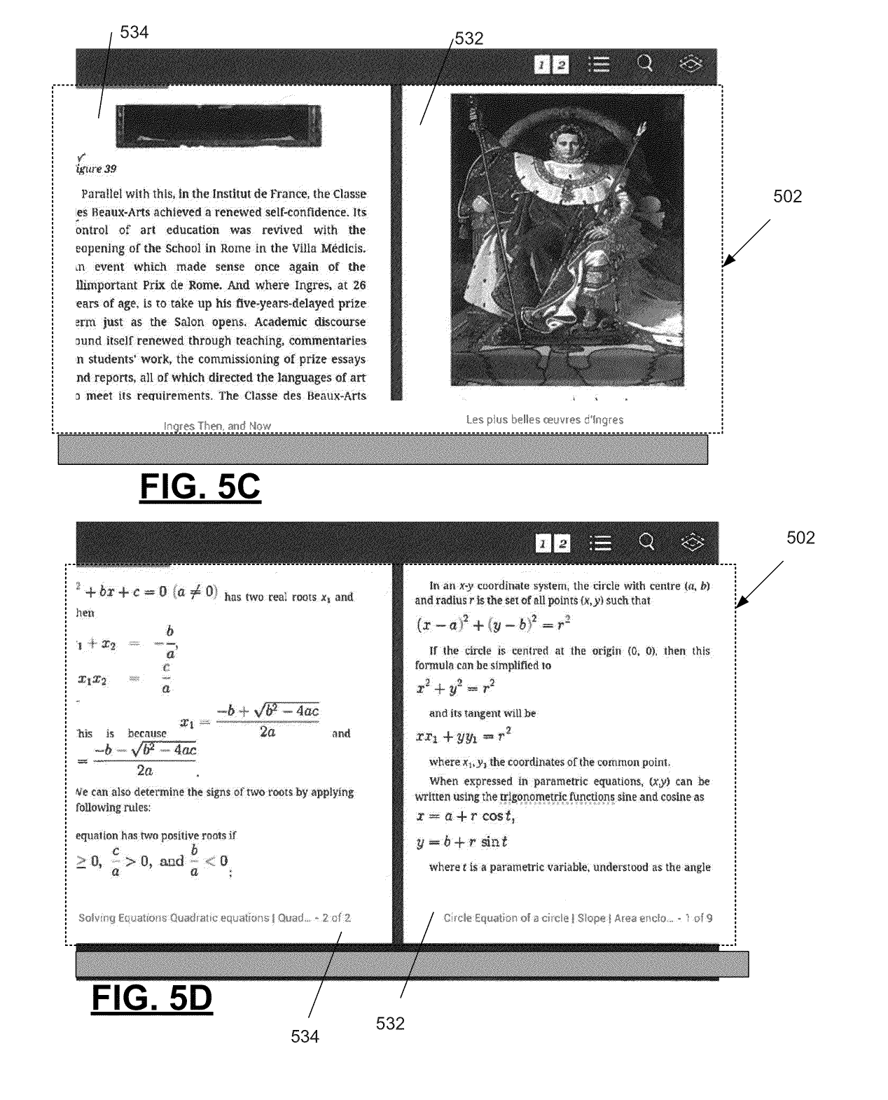

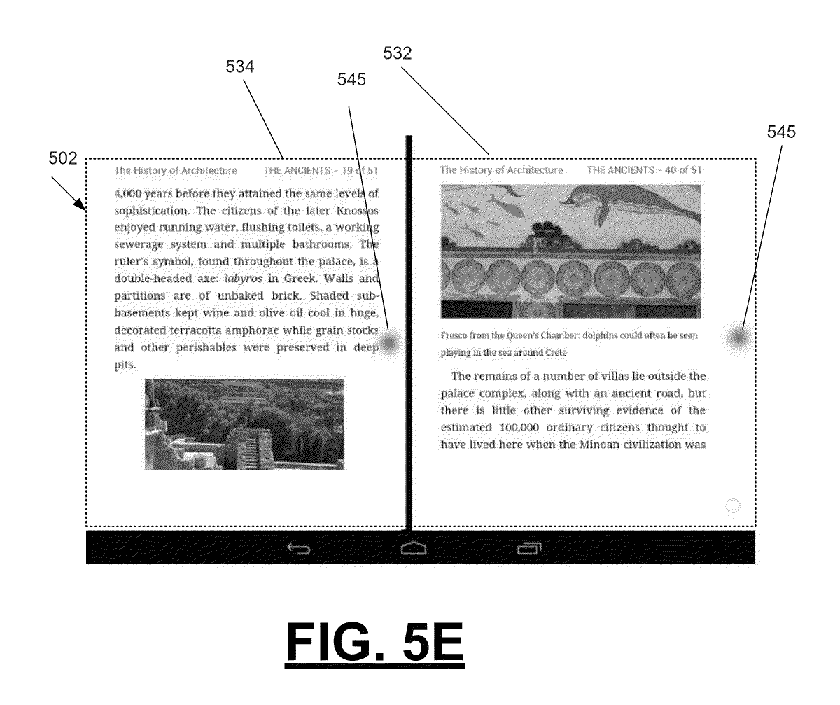

FIG. 5A illustrates an example of content displayed by an e-reader device 110 when operating in a default single view mode, according to an embodiment. A display area 502 of the e-reader device can display a page view 510. The page view 510 can correspond to content from a selected e-book. The content provided with the page view 510 can, for example, be displayed as a single page, or as in the example shown, displayed as multiple pages. While multiple pages can be displayed in the single view mode, the single view mode can be characterized by a same process or instance operating on the computing device in order to present multiple pages of content from the e-book at one time. Thus, for example, no logical partition may exist between the concurrently displayed pages of the e-book when operated in the single view mode. Furthermore, the pages of the e-book are linked when the e-reader device is operated in the single view mode. For example, when the user enters a page turn input in the single view mode, the resulting page transition changes both pages on display in the same manner.

In the example of FIG. 5A, a multi-view selection feature 512 is provided to enable the user to switch into a mufti-view mode. In the multi-view mode, the display area is logically partitioned, so that, for example, content appearing with each segment is not linked with the content of the other segment.

FIG. 5B illustrates an example of the page view 510 after an initial user interaction with the mufti-view selection feature 512. In one implementation, the user can interact with the multi-view selection feature 512 in order to select to switch into the mufti-view mode, and further to select what content is to be displayed in the alternative segment that is to be created when the multi-view is implemented. For example, a panel 522 can display or list options 523 for the user as to what content can be displayed in the alternative segment once the mufti-view mode is implemented. In the example provided, the options provided include library selection (e.g., for displaying the library view), page selection (e.g., for displaying another page of the same e-book as a separate instance), or online are e-book store (e.g., such as provided by network service 120). Alternatively, the list can include options for enabling the user to select an e-book. For example, the list provided with panel 522 can display e-book titles as one of the options 523.

FIG. 5C illustrates an example of a multi-view implementation in which the segments of the display area separately display content from different e-books. In the example of FIG. 5C, the display area 502 is partitioned into a first segment 532 and a second segment 534. Content from the current e-book can be displayed in the first segment 532. For example, the last page that the user read before selecting the mufti-view feature 512 (e.g., the last page rendered on the display area) can be automatically provided in the first segment 532, and content from a new or different e-book can be displayed in the second segment 534.

According to some embodiments, each of the first and second segments 532, 534 can be provided with input features that enable the user to independently interact with the content provided in each of the respective segments. The input features can enable, for example, page turning, chapter turning, setting selection, or dictionary and/or translation lookup. The respective first and second segments can replicate some or all of the same set of features.

In an example of FIG. 5C in which each segment 532, 534 displays content from a different e-book, the selection of a page turn feature, for example, can cause the e-reader device 110 to transition pages of the e-book that is displayed through the segment where the input is received, while the content appearing in the other segment is not affected. In this way, the input features can be operated in a manner that only affects the particular segment where the input feature is provided. As such, the content appearing in the two segments are not linked, but rather logically partitioned.

Still further, in some variations, some input features can be globally applied to both segments 532, 534. For example, input features for specifying setting selections can be applied globally to both segments 532, 534, so that the selection of a particular setting affects both segments equally. In a variation, however, the setting selection feature can be provided for each segment 532, 534, so that the selection of a particular setting in one segment affects only the content appearing in that segment.

FIG. 5D illustrates an example of a mufti-view implementation in which the segments of the display area separately display content from different portions of the same e-book. For example, when the multi-view feature 512 (see FIG. 5B) is selected and the options are provided in the panel 522 (see FIG. 5B), the user can select to view content from the same e-book as one of the options. A separate process or instance of the same e-book can be opened in the second segment 534. As with an example of FIG. 5C, each segment can be provided its own input features, to enable the user to independently perform input actions that alter the content of one segment but not the other. For example, the user can provide page turn input on one segment in order to cause the e-book to transition pages in that segment, without affecting the display of content from the same e-book and the other segment.

FIG. 5E illustrates a mufti-page view in which input features are provided for each segment of the display area 502, according to an embodiment. In the example provided, each segment 532, 534 displays content from a corresponding e-book. As mentioned with other examples, each segment 532, 534 can be provided its own set of input features. For example, each segment can be provided with the page turn feature 545. The page turn feature 545 can be iconic and visible, or hidden (e.g., region of contact).

When the mufti-view mode is implemented, the user can interact with each segment independently of the other segment, using, for example, the page turn feature 545. For example, the user can specify page turn input on each segment by touching a region that is at or near the edge of the particular segment. When the user provides the page turn input for a particular segment (through interaction with input feature 545), the page transition occurs in the segment where the interaction occurred, and not in the other segment. Thus, the page turn input is handled only by the segment that receives the input.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computer system comprising:
a memory;
a display; and
one or more processors to use instructions stored in the memory to:
execute an e-reader application to display a content from a first e-book, the e-reader application including a first set of features for use with the first e-book;
while displaying the content from the first e-book, implement a partition that segments a display area of the display into a first segment and a second segment;
wherein the one or more processors further implement the partition by:
providing the content and the first set of features on only the first segment,
enabling selection of another resource from a plurality of possible resources using the e-reader application, and
in response to selection of the other resource, display content based on the selected other resource on only the second segment of the display area.

2. The computer system of claim 1, wherein the one or more processors implement the partition by providing the first set of features for use with the e-reader application operating to display content from the first e-book on only the first segment, and a second set of features for use with the second resource on only the second segment, wherein the first and second set of features operate independently of one another.

3. The computer system of claim 1, wherein the plurality of possible resources includes two or more resources selected from a group that includes (i) a second e-book, (ii) a library presentation of e-books stored on the computing device or associated with a user account, or (iii) a second instance of the first e-book.

4. The computer system of claim 1, wherein the one or more processors enable selection of another resource by enabling a user to select a second e-book, and wherein the one or more processors display content from the second e-book in only the second segment of the display area.

5. The computing device of claim 4, wherein the one or more processors provide, on the second segment of the display area, a second set of features for use with the second e-book.

6. The computing device of claim 5, wherein the first and second set of features each include a page turning feature which is provided on an edge region of each of the first and second segments.

7. The computing device of claim 6, wherein the page turning feature of each of the first and second set of features includes a touch-sensitive region provided on the edge region of each of the first and second segment of the display area respectively, the page turning feature of each of the first and second set of features enabling a user to provide an input corresponding to one of a page turn, a mufti-page turn or a chapter turn.

8. The computer system of claim 6, wherein the page turning feature provided with each of the first and second set of features is hidden on the respective first and second segment of the display area.

9. The computer system of claim 1, wherein the one or more processors enable selection of another resource by enabling a user to select a second instance of the first e-book, and wherein the one or more processors display content from a first page of the e-book in the first segment, and content from a second page in the e-book in the second segment, the first and second page not being consecutive.

10. The computer system of claim 9, further comprising providing the first set of features with the first segment, and a second set of features with the second segment, each of the first and second sets of features being operable by the user to independently control the content appearing on each of the first segment and the second segment.

11. The computing device of claim 4, wherein the one or more processors provide at least some of the first set of features in response to a user pre-selection that occurs on the first segment of the display area, and at least some of the second set of features in response to a user pre-selection that occurs on the second segment of the display area.

12. The computing device of claim 11, wherein the at least some of the first set of features and the at least some of the second set of features each include at least one of (i) a settings feature that is selectable to after a setting of content provided on the respective first or second segment, and/or (ii) a dictionary feature is that is selectable to provide a dictionary feature on selected words provided on the respective first or second segment.

13. The computer system of claim 1, wherein the one or more processors provide a multi-view feature with a menu when displaying content from the first e-book, then implement the partition in response to a user input provided through interaction with the mufti-view feature.

14. A non-transitory computer-readable medium that stores instructions that, when executed by one or more processors, cause the one or more processors to perform operations that comprise:
executing an e-reader application to display a content from a first e-book, the e-reader application including a first set of features for use with the first e-book;
while displaying the content from the first e-book, implementing a partition that segments a display area of a display into a first segment and a second segment;
wherein the instructions cause the one or more processors to further implement the partition by:
providing the content and the set of features on only the first segment,
enabling selection of another resource from a plurality of possible resources using the e-reader application, and
in response to selection of the other resource, display content based on the selected other resource on only the second segment of the display area.

15. The non-transitory computer-readable medium of claim 14, wherein implementing the partition is performed by providing the first set of features for use with the e-reader application operating to display content from the first e-book on only the first segment, and a second set of features for use with the second resource on only the second segment, wherein the first and second set of features operate independently of one another.

16. The non-transitory computer-readable medium of claim 14, wherein the plurality of possible resources includes two or more resources selected from a group that includes (i) a second e-book, (ii) a library presentation of e-books stored in memory or associated with a user account, or (iii) a second instance of the first e-book.

17. The non-transitory computer-readable medium of claim 14, wherein enabling selection of another resource includes enabling a user to select a second e-book, the content from the second e-book being displayed in the second segment of the display area when the partition is implemented.

18. The non-transitory computer-readable medium of claim 14, further comprising providing, on the second segment of the display area, a second set of features for use with the second e-book.

19. The non-transitory computer-readable medium of claim 18, wherein the first and second set of features each include a page turning feature which is provided on an edge region of each of the first and second segments.

20. A computer-implemented method for operating an e-reader device, the method comprising:
executing an e-reader application to display a content from a first e-book, the e-reader application including a first set of features for use with the first e-book; and
while displaying the content from the first e-book, implementing a partition that segments a display area of a display into a first segment and a second segment, wherein implement the partition includes:
providing the content and the first set of features on only the first segment,
enabling selection of another resource from a plurality of possible resources using the e-reader application, and
in response to selection of the other resource, display content based on the selected other resource on only the second segment of the display area.
